(19) United States
(12) Patent Application Publication
(10) Pub. No.: US 2008/0102818 A1
(43) Pub. Date: May 1, 2008

(54) METHOD AND COMPUTER PROGRAM PRODUCT FOR MANAGING PRIVILEGES OF A COMMUNICATIONS DEVICE

(75) Inventor: James McArdle, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/553,695

(22) Filed: Oct. 27, 2006

(51) Int. Cl. H04Q 7/20

(52) U.S. Cl. 455/425

(57) ABSTRACT

A method for a principal to modify privileges of a communications device of an agent, is provided and includes: determining a set of instructions for modifying the privileges; loading the set of instructions into a communications infrastructure for the communications device; and modifying the privileges by at least one of restricting, changing and resetting the privileges. Also disclosed is a computer program product for implementing the method.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The teachings herein relate to mobile telephones, and in particular, to techniques for remote control thereof.

2. Description of the Related Art

Many parents today give their kids cell phones, with the purpose of keeping in touch with them. The kids typically view the benefits of having a cell phone as a great new tool for freedom. They can call friends at anytime; get rides to anywhere; call home for help. They also learn that the caller ID function provides the cell phone with an ability to tune out parents.

What are needed are techniques for regaining control of the cell phone from a remote location.

### SUMMARY OF THE INVENTION

The shortcomings of the prior art are overcome and additional advantages are provided through the provision of a method for a principal to modify privileges of a communications device of an agent, the method including: determining a set of instructions for modifying the privileges; loading the set of instructions into a communications infrastructure for the communications device; and modifying the privileges by at least one of restricting, changing and resetting the privileges.

Also disclosed is a computer program product stored on machine readable media including instructions for a principal to modify privileges of a communications device of an agent, the instructions including: determining a set of instructions for modifying the privileges; loading the set of instructions into a communications infrastructure for the communications device; and modifying the privileges by at least one of restricting, changing and resetting the privileges.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program product stored on machine readable media is provided. The solution includes instructions for a principal including one of a parent and an employer to modify privileges of a communications device of an agent including a respective one of a child and an employee, the device including at least one of a cellular telephone, a satellite telephone, a mobile station, a home telephone, a business telephone and a fixed telephone, the instructions including: determining a set of instructions for modifying the privileges; loading the set of instructions into a communications infrastructure by entering the set of instructions using at least one of using a communications device and a user web access for the communications device; and modifying the privileges by at least one of restricting, changing and resetting the privileges; wherein restricting includes at least one of disabling calling to a certain telephone number, receiving calls from a certain telephone number, sending text messages, receiving text messages and accessing voice mail; and wherein changing includes at least one of changing a ring tone, redirecting an incoming call and redirecting an outgoing call.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a communications infrastructure;

FIG. 2 illustrates aspects of a set of instructions for managing a communications device; and

FIG. 3 illustrates an exemplary method for managing the communications device.

The detailed description explains the preferred embodiments of the invention, together with advantages and features, by way of example with reference to the drawings.

### DETAILED DESCRIPTION OF THE INVENTION

The teachings herein provide for controlling certain functions of a mobile station. The controlling includes, for example, remotely shutting down aspects of the mobile station. As another example, the controlling may include redirecting of incoming or outgoing calls. Typically, the controlling (such as the remote shutdown) is undertaken by a principal user (a party other than an operator). An agent, having custody of the mobile station, is typically required to contact the principal to restore the certain functions.

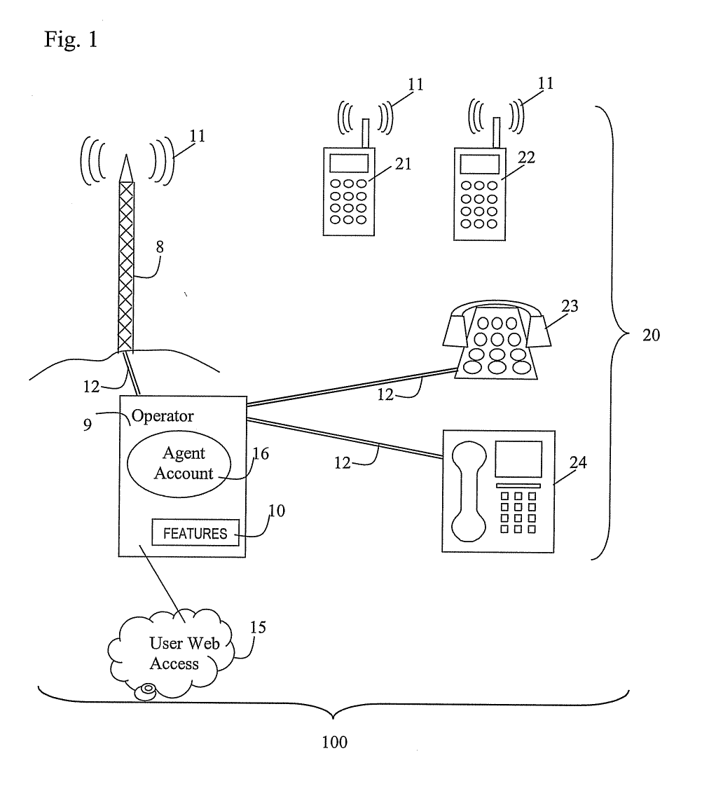

Referring now to FIG. 1, aspects of an exemplary communications infrastructure 100 are shown. The communications infrastructure 100 depicted herein includes a plurality of communications devices 20. Exemplary communications devices 20 include mobile stations, such as a cellular telephone 21 (also referred to as a “cell phone”) and a satellite telephone 22. Typically, the mobile stations communicate with the communications infrastructure 100 by use of a radio signal 11 produced by a radio tower 8. Other communications devices 20 include fixed stations such as, and without limitation, a home telephone 23 and a business telephone 24. Typically, the fixed stations communicate with the communications infrastructure 100 by use of communications lines 12.

As a non-limiting example, and in particular with regard to an example of the cell phone 21, the communications devices 20 typically include certain features and capabilities. For example, the cell phone includes features such as memory, a processor, at least one speaker, a power on/off switch, a display and other such components. Capabilities are typically provided by implementation of machine readable instructions provided therein (or downloaded thereto). Capabilities include, for example, caller ID, a database for telephone numbers, various ringtones and other such aspects. These features and capabilities are merely illustrative.

In typical embodiments, the communications infrastructure 100 is managed by an operator 9. As used herein, the operator 9 includes all resources necessary for operating and maintaining the communications infrastructure 100. Exemplary components, generally not depicted herein (for purposes of simplicity), include, without limitation: computers and components thereof, power supplies, personnel, communications networks, etc, . . . As examples of components of the operator 9, the communications lines 12 as well as the radio signal 11 are used to connect a base station (not shown) of the operator 9 with the various communications devices 20.

In some embodiments, principals are provided access to and control over an agent account 16 maintained by the operator 9. Exemplary types of access include user web access 15 available through the Internet.

The communications infrastructure may include any one or more of a cellular network, a fixed network, a private network (such as a corporate network), or any other type of communications infrastructure 100.

A calling feature 10 for the communications infrastructure 100, as disclosed herein, may be implemented through various techniques. For example, the calling feature 10 may be implemented as software including machine readable instructions stored as a computer program product. The computer program product, or software, may be stored using any one or more of a variety of media. Non-limiting examples of media include, magnetic media, optical media, magneto-optical media, read-only memory (ROM), random-access memory (RAM), a flash memory, a hard drive, a tape drive and others. Typically, the storage is a provided for within resources of the operator 9. However, in some embodiments, the storage may be included, at least in part, within the communications devices 20. In one embodiment, at least a portion of the calling feature 10 is manually implemented by call center personnel.

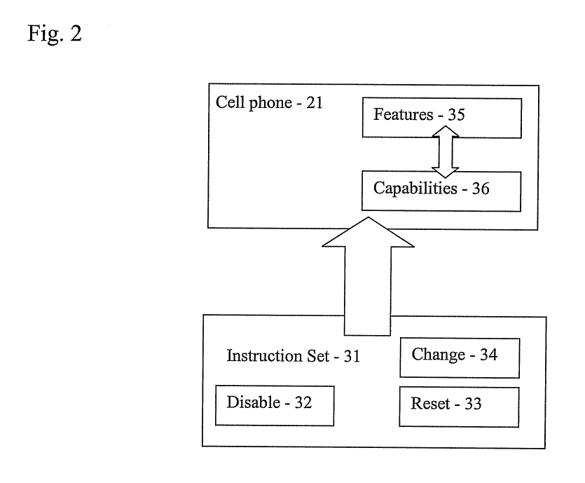

In order to provide some context for the calling feature 10, consider aspects of some present day systems. In typical present day systems, a mobile station, such as the cellular telephone 21 is enabled to male and receive calls. The capability to make and receive calls is usually unrestricted. That is, this capability usually provides for communication without regard to the identity of the other party. Consider now, the teachings illustrated in FIG. 2.

As depicted in FIG. 2, the cell phone 21, which includes certain features 35 and capabilities 36, receives an instruction set 31. The instruction set 31 includes at least one of a disable instruction 32, a reset instruction 33 and a change instruction 34. Each of the disable instructions 32, the reset instructions 33 and the change instructions 34 may be designated for any one or more of a plurality of the features 35 and the instructions 36. In this embodiment, the instruction set 31 is downloaded to the cell phone 21. However, in some other embodiments, the operator 9 receives and implements (at least some aspects of) the instruction set 31. Among other things, the instruction set 31 provides for remote modification to a privilege of the communications device 20.

Exemplary instructions include instructions for disabling at least one of calling to a certain telephone number, receiving calls from a certain telephone number, sending text messages, receiving text messages, accessing voice mail and other such functions. Examples of changes include modification to a ring tone, redirection of incoming or outgoing calls, and others. One example of redirection includes identifying a call placed by the agent to a third party and redirecting the call to the principal. Exemplary reset instructions provide for resetting any prior instructions (i.e., restoration of normal functionality). Of course, these examples are merely illustrative and are not limiting of the teachings herein.

As one skilled in the art will understand, instructions 31 that may be implemented by the operator 9 include instructions 31 for limiting communication between the agent and third parties, as well as call redirection features.

The principal is typically provided access to the calling feature 10 through at least one of two ways. A first way includes use of communications devices 20 (such as by keying in of passwords and instructions 31). In this technique, the principal may have access to the instructions 31 via typical voice menu systems as are known in the art. A second way calls for use of the user web access 15. Also known in the art, the user web access 15 is typically configured to provide for comprehensive control in a rapid fashion.

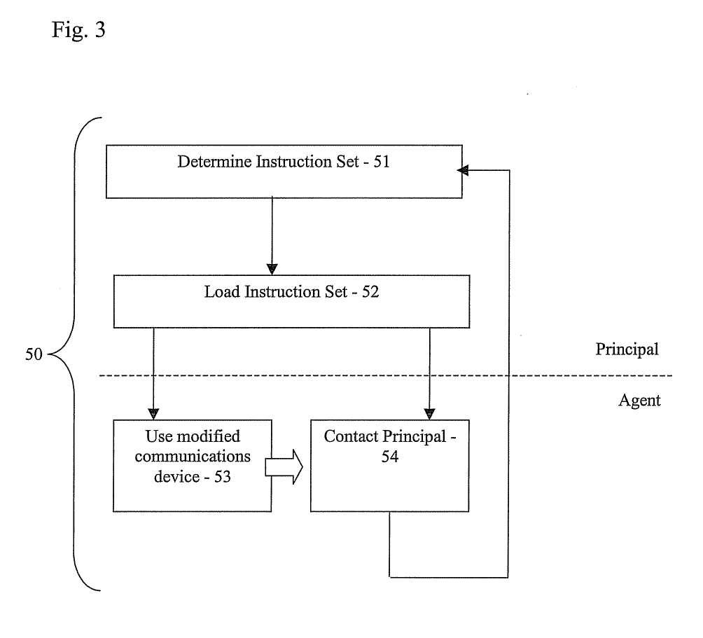

Anyone who has used communications devices 20, waited for a call, or been obliged to pay for the service, will understand aspects of the functionality of the calling feature 10. One method for use of the teachings herein is depicted in FIG. 3.

In FIG. 3, controlling the communications device 50 calls for the principal determining the set of instructions 51 and loading the set of instructions 52 to provide for a modified communications device 20. The agent then is provided with a choice of using the modified communications device 53 (typically having restrictions thereon) and contacting the principal 54.

The process for controlling the communications device 50 then repeats. That is, the principal will typically, at some point, again determine and load the set of instructions to provide for the modified communications device 20. This repeat of the process may actually (typically) call for resetting (i.e., removing any restrictions) of the communications device 20.

As one skilled in the art might surmise, the calling feature 10 typically includes security to prevent the agent from defeating instructions such as a restriction. In one example, the security may be modified by the principal using a security code (i.e., a password). In other embodiments, the security is maintained by the operator 9.

In an example, the teachings provide for a parent temporarily shutting down a cell phone of a child for all incoming calls except those of the parent. Other variations might include changing the ring-tone to a more irritating one to get the kids attention. In further embodiments, the teachings provide for, as an example, shutting down the cell phone 21 of the agent to all incoming calls and outgoing calls except when the other party is the principal (with, in some embodiments, emergency calling privileges, such as to 911, left intact).

In some embodiments, the principal is provided with an ability to schedule restrictions for the communications device 20. For example, in some embodiments, the parent is provided with a capability to restrict calling by or to the child during school hours.

The feature could be implemented as either a network feature provided by the cell phone company or a local software feature of the phone where the parents phone is considered the principal and the child's phone the agent. The principal would typically have certain rights and privileges on the child's phone such as monitoring the phone log, phone directory remotely. The parents could restrict the phone to worldling at select times during the day, can decide who the child can and can't talk to.

Other uses for this technology would be employers trying to get in touch with employees who choose not to answer phones for various reasons. Of course, other business relationships may be construed, for convenience as “employer and employee.” Examples include owner and contractor or subcontractor relationships.

The calling feature 10 may be integrated with other calling plans. For example, the calling feature 10 may be included as a part of a group calling plan (e.g., a family plan) where one or two mobile stations are identified as having principal status.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for a principal to modify privileges of a communications device of an agent, the method comprising:
determining a set of instructions for modifying the privileges;
loading the set of instructions into a communications infrastructure for the communications device; and
modifying the privileges by at least one of restricting, changing and resetting the privileges.

2. The method as in claim 1, wherein the loading comprises entering the set of instructions by at least one of using a communications device and a user web access.

3. The method as in claim 1, wherein the communications device comprises at least one of a cellular telephone, a satellite telephone, a mobile station, a home telephone, a business telephone and a fixed telephone.

4. The method as in claim 1, wherein the principal comprises one of a parent and an employer.

5. The method as in claim 1, wherein the agent comprises one of a child and an employee.

6. The method as in claim 1, wherein restricting comprises at least one of disabling calling to a certain telephone number, receiving calls from a certain telephone number, sending text messages, receiving text messages and accessing voice mail.

7. The method as in claim 1, wherein modifying the privileges comprises modifying according to a time of day.

8. The method as in claim 1, wherein changing comprises at least one of changing a ring tone, redirecting an incoming call and redirecting an outgoing call.

9. A computer program product stored on machine readable media comprising instructions for a principal to modify privileges of a communications device of an agent, the instructions comprising:
determining a set of instructions for modifying the privileges;
loading the set of instructions into a communications infrastructure for the communications device; and
modifying the privileges by at least one of restricting, changing and resetting the privileges.

10. The computer program product as in claim 9, wherein the loading comprises entering the set of instructions by at least one of using a communications device and a user web access.

11. The computer program product as in claim 9, wherein the communications device comprises at least one of a cellular telephone, a satellite telephone, a mobile station, a home telephone, a business telephone and a fixed telephone.

12. The computer program product as in claim 9, wherein the principal comprises one of a parent and an employer.

13. The computer program product as in claim 9, wherein the agent comprises one of a child and an employee.

14. The computer program product as in claim 9, wherein restricting comprises at least one of disabling calling to a certain telephone number, receiving calls from a certain telephone number, sending text messages, receiving text messages and accessing voice mail.

15. The computer program product as in claim 9, wherein changing comprises at least one of changing a ring tone, redirecting an incoming call and redirecting an outgoing call.

16. A computer program product stored on machine readable media comprising instructions for a principal comprising one of a parent and an employer to modify privileges of a communications device of an agent comprising a respective one of a child and an employee, the device comprising at least one of a cellular telephone, a satellite telephone, a mobile station, a home telephone, a business telephone and a fixed telephone, the instructions comprising:
determining a set of instructions for modifying the privileges;
loading the set of instructions into a communications infrastructure by entering the set of instructions using at least one of using a communications device and a user web access for the communications device; and
modifying the privileges by at least one of restricting, changing and resetting the privileges;
wherein restricting comprises at least one of disabling calling to a certain telephone number, receiving calls from a certain telephone number, sending text messages, receiving text messages and retrieving voice mail; and
wherein changing comprises at least one of changing a ring tone, redirecting an incoming call and redirecting an outgoing call.
